(19) United States
(12) Patent Application Publication
(10) Pub. No.: US 2026/0237958 A1
(43) Pub. Date: Aug. 13, 2026

(54) COMPACT HIGH-REPETITION-RATE PASSIVE MODE-LOCKED RESONANT CAVITY STRUCTURE AND FIBER LASER

(71) Applicant: SOUTH CHINA UNIVERSITY OF TECHNOLOGY, Guangzhou (CN)

(72) Inventors: Xiaoming WEI, Guangzhou (CN); Lin LING, Guangzhou (CN); Wenlong WANG, Guangzhou (CN); Zhongmin YANG, Guangzhou (CN)

(73) Assignee: SOUTH CHINA UNIVERSITY OF TECHNOLOGY, Guangzhou (CN)

(21) Appl. No.: 19/160,044

(22) PCT Filed: Apr. 3, 2023
(86) PCT No.: PCT/CN2023/086043

§ 371 Date: Aug. 27, 2025

(30) Foreign Application Priority Data
Feb. 27, 2023 (CN) 202310170840.1

(51) Int. Cl. H01S 3/1118; H01S 3/067

(52) U.S. Cl. CPC H01S 3/1118; H01S 3/06716

(57) ABSTRACT

Discloses are a compact high-repetition-rate passive mode-locked resonant cavity structure and a fiber laser, where a resonant cavity includes a first ferrule, a semiconductor saturable absorber mirror, a first sleeve, a gradient index lens, a second sleeve, a gain fiber, a second ferrule, and a dielectric film. The semiconductor saturable absorber mirror is disposed on one end surface of the first ferrule, the first ferrule is spacedly connected to one end of the gradient index lens via the first sleeve, the other end of the gradient index lens is spacedly connected to the second ferrule via the second sleeve, the dielectric film is disposed on the other end surface of the second ferrule, and the gain fiber is located in the second ferrule.

### TECHNICAL FIELD

The present invention pertains to the field of laser technology, and specifically relates to a compact high-repetition-rate passive mode-locked resonant cavity structure and a fiber laser.

### BACKGROUND

High-repetition-rate laser pulses, characterized by short pulse intervals and large longitudinal mode spacing, hold significant research value and application potential in numerous fields such as optical frequency measurement, high-speed optical sampling, ultra-high-speed optical communication, precision machining, and biomedical applications. Meanwhile, due to the characteristics of optical fibers, such as small size, light weight, and flexibility, fiber lasers using optical fibers as the gain medium offer advantages such as compact structure and strong heat dissipation capabilities. Additionally, their low manufacturing costs and high optical-to-optical conversion efficiency make them highly favored in scientific research and commercial applications, positioning fiber lasers as the preferred research subject for obtaining highly reliable, high-pulse-quality laser sources.

Mode-locking is an important technique for generating picosecond or even femtosecond ultra-short pulses, and it can be classified into active mode-locking and passive mode-locking based on different mode-locking methods. Active mode-locking involves introducing active factors into the laser resonant cavity to periodically modulate the amplitude or phase of the intra-cavity light field, establishing a fixed phase relationship between different modes in the laser resonant cavity. In contrast, passive mode-locking involves incorporating a natural saturable absorber or an equivalent saturable absorber into the resonant cavity. Through the saturable absorption effect, strong and weak optical signals experience the same gain but significantly different losses during simultaneous round-trips in the resonant cavity, resulting in stable oscillation of strong optical pulses while weak signals gradually diminish, achieving stable self-starting of intra-cavity laser pulses and forming a sequence of ultra-short laser pulses with a period

$$T = \frac{2 L}{c}$$

(L represents the resonant cavity length L and c represents the speed of light). Compared with active mode-locked lasers, which are costly and structurally complex, passive mode-locked lasers, requiring no external modulation to achieve mode-locked pulse output, have a simpler and more compact structure, more stable performance, and are more capable of achieving high-repetition-rate femtosecond mode-locked pulse output.

The semiconductor saturable absorber mirror, commonly used as a saturable absorber in passive mode-locking technology, is formed by directly growing special semiconductor materials on a semiconductor Bragg reflector, with an additional reflective layer grown on the top, or by directly utilizing the semiconductor-air interface as a reflector. The combination of the upper and lower reflectors forms a Fabry-Perot cavity, resulting in a reflector with saturable absorption properties. The modulation depth and bandwidth of the saturable absorption can be adjusted by varying the thickness of the absorber or the reflectivity of the two reflectors. Due to its compact structure and ability to achieve self-starting mode-locking, the semiconductor saturable absorber mirror is widely applied in passive mode-locked fiber lasers (Song D, Yin K, Miao R, et al. Theoretical and experimental investigations of dispersion-managed, polarization-maintaining 1-GHz mode-locked fiber lasers [J]. Optics Express, 2023, 31(2): 1916-1930.). Additionally, its low non-saturated loss and modulation depth help suppress Q-switching instability in high-repetition-rate fundamental mode-locked operations. To achieve GHz-level high-repetition-rate passive mode-locked pulse output, the resonant cavity length of fiber lasers is restricted to the centimeter scale. Due to the limitations of the gain coefficient of the gain fiber, most high-repetition-rate passive mode-locked fiber laser designs currently rely on direct contact between the end face of the gain fiber and the semiconductor saturable absorber mirror to achieve efficient optical reflection. However, this approach is prone to damaging the surface of the semiconductor saturable absorber mirror, thereby disrupting stable mode-locking states (for example, leading to Q-switching instability). When Q-switching instability occurs, the high peak power generated by the fiber laser further damages the semiconductor saturable absorber mirror. Additionally, this design is not conducive to dissipating the heat generated by the laser on the semiconductor saturable absorber mirror. The accumulated high heat during prolonged mode-locked operation permanently damages the mode-locking components, affecting the performance of high-repetition-rate passive mode-locked fiber lasers.

### SUMMARY

To overcome the shortcomings of the existing technology, an objective of the present invention is to provide a compact high-repetition-rate passive mode-locked resonant cavity structure, where the resonant cavity structure is a Fabry-Perot cavity structure. By means of incorporating a gradient index lens between the semiconductor saturable absorber mirror and the gain fiber, direct contact between the semiconductor saturable absorber mirror and the fiber end face is avoided, enabling good heat dissipation of the resonant cavity while achieving high-repetition-rate mode-locked pulse output, and preventing damage to the fiber laser during prolonged mode-locked operation.

The present invention is achieved through at least one of the following technical solutions.

A compact high-repetition-rate passive mode-locked resonant cavity structure is provided, where the resonant cavity includes a first ferrule, a semiconductor saturable absorber mirror, a first sleeve, a gradient index lens, a second sleeve, a gain fiber, a second ferrule, and a dielectric film.

The semiconductor saturable absorber mirror is disposed on one end surface of the first ferrule, the first ferrule is spacedly connected to one end of the gradient index lens via the first sleeve, the other end of the gradient index lens is spacedly connected to the second ferrule via the second sleeve, the dielectric film is disposed on the other end surface of the second ferrule, and the gain fiber is located in the second ferrule.

Further, the first sleeve is provided on an outer side of the first ferrule and the gradient index lens, and the second sleeve is provided on an outer side of the second ferrule and the gradient index lens.

Further, distances from the gradient index lens to the semiconductor saturable absorber mirror and the gain fiber are adjustable.

Further, a material refractive index distribution of the gradient index lens gradually decreases along a radial direction, causing continuous refraction of light during axial transmission, and achieving smooth and continuous convergence of light rays to a point.

Further, the dielectric film has a reflectivity greater than 70% for signal light and a transmittance greater than 70% for pump light.

Further, a modulation depth of the semiconductor saturable absorber mirror is from 1% to 30%.

Further, a length of the gain fiber is from 1 cm to 9 cm.

Further, the gain fiber is a fiber doped with rare earth ions, and the rare earth ions for doping include one or more types of erbium, ytterbium, thulium, and holmium.

Further, the gain fiber is fixed in the second ferrule with a matched size using epoxy resin, and a polishing treatment is performed at an end surface.

A fiber laser including the compact high-repetition-rate passive mode-locked resonant cavity structure is provided, including a wavelength division multiplexer, a pump source, an optical isolator, and the resonant cavity.

The wavelength division multiplexer is configured to couple pump light generated by the pump source into the resonant cavity and output generated signal light out of the resonant cavity, and the optical isolator is connected to the wavelength division multiplexer.

Compared with the existing technology, the present invention has the following beneficial effects:

According to the compact high-repetition-rate passive mode-locked resonant cavity structure provided by the present invention, the provision of the gradient index lens between the semiconductor saturable absorber mirror and the gain fiber avoids direct contact between the semiconductor saturable absorber mirror and an end surface of the fiber, thereby suppressing damage to the semiconductor saturable absorber mirror caused by heat accumulation from the gain fiber during prolonged mode-locked operation, and enabling good heat dissipation of the resonant cavity while achieving high-repetition-rate mode-locked pulse output.

### BRIEF DESCRIPTION OF DRAWINGS

To more clearly illustrate the technical solutions of the embodiments of the present invention, the drawings required for use in the embodiments are briefly introduced below. It should be understood that the following drawings only illustrate some embodiments of the present invention and therefore should not be considered as limiting the scope. For those of ordinary skill in the art, other related drawings can be obtained based on these drawings without creative effort.

FIG. 1 is a schematic diagram of a high-repetition-rate passive mode-locked resonant cavity structure according to an embodiment of the present invention.

FIG. 2 is a schematic diagram of a propagation path trajectory of light in a gradient index lens according to an embodiment of the present invention.

FIG. 3 is a principal diagram of a structure of a high-repetition-rate passive mode-locked fiber laser according to an embodiment of the present invention.

Wherein:
1. first ferrule; 2. semiconductor saturable absorber mirror; 3. first sleeve; 4. gradient index lens; 5. second sleeve; 6. gain fiber; 7. second ferrule; 8. dielectric film; 9. resonant cavity; 10. wavelength division multiplexer; 11. pump source; and 12. isolator.

### DETAILED DESCRIPTION OF EMBODIMENTS

The technical solutions in the embodiments of the present invention are clearly and completely described below with reference to the drawings in the embodiments of the present invention. It is apparent that the described embodiments are only some of the embodiments of the present invention, not all of them. Based on the embodiments of the present invention, all other embodiments obtained by those of ordinary skill in the art without creative effort fall within the scope of protection of the present invention.

To make the above objectives, features, and advantages of the present invention more apparent and understandable, the technical solutions of the present invention are further described in detail below with reference to the drawings and specific implementation examples. It should be noted that the specific embodiments described here are only used to explain the present application and are not used to limit the present application.

### Embodiment 1

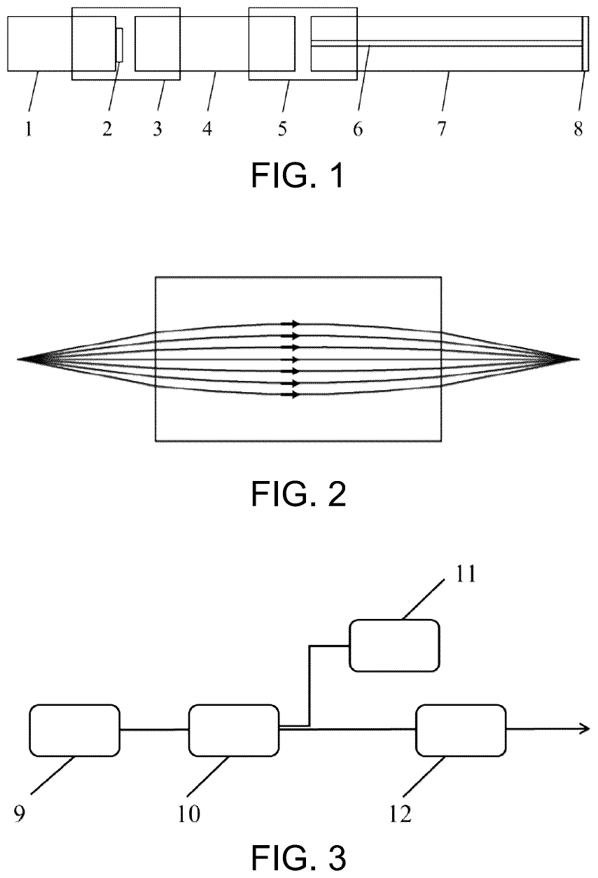

As shown in FIG. 1, this embodiment provides a compact high-repetition-rate passive mode-locked resonant cavity structure, where the resonant cavity 9 includes a first ferrule 1, a semiconductor saturable absorber mirror 2, a first sleeve 3, a gradient index lens 4, a second sleeve 5, a gain fiber 6, a second ferrule 7, and a dielectric film 8.

The semiconductor saturable absorber mirror 2 is disposed on one end surface of the first ferrule 1, the first ferrule 1 is spacedly connected to one end of the gradient index lens 4 via the first sleeve 3, the other end of the gradient index lens 4 is spacedly connected to the second ferrule 7 via the second sleeve 5, the dielectric film 8 is disposed on the other end surface of the second ferrule 7, the gain fiber 6 is located in the second ferrule 7, the first sleeve 3 is provided on an outer side of the first ferrule 1 and the gradient index lens 4, and the second sleeve 5 is provided on an outer side of the second ferrule 7 and the gradient index lens 4.

In practical applications, the resonant cavity 9 is a Fabry-Perot cavity structure with an overall length of less than 10 cm, capable of achieving high-repetition-rate mode-locked pulse output greater than 1 GHZ.

Distances from the gradient index lens 4 to the semiconductor saturable absorber mirror 2 on the first ferrule 1 and the gain fiber 6 in the second ferrule 7 can be adjusted to control the spot size of light incident on the semiconductor saturable absorber mirror 2 and optimize coupling efficiency. As shown in FIG. 2, FIG. 2 a schematic diagram of a propagation path trajectory of light in the gradient index lens 4 according to an embodiment of the present invention. A material refractive index distribution of the gradient index lens 4 gradually decreases along a radial direction, enabling continuous refraction of light during axial transmission, achieving smooth and continuous convergence of light rays to a point, and realizing a self-focusing function.

The dielectric film 8 is a dichroic dielectric film applied to one end surface of the second ferrule 7 by plasma sputtering, with a film system thickness of 13 μm, a reflection center wavelength of 1064 nm, a reflection bandwidth of 1010 nm-1080 nm, a reflectivity greater than 85%, a transmission center wavelength of 976 nm, and a transmittance greater than 90%.

The semiconductor saturable absorber mirror 2 is fixed on one end surface of the first ferrule 1, formed by directly growing special semiconductor materials on a semiconductor Bragg reflector and growing an additional reflective layer on the top. The combination of the upper and lower reflectors forms a Fabry-Perot cavity, constituting a reflector with saturable absorption property, with a center wavelength of 1040 nm, a reflection bandwidth of 1020 nm-1100 nm, an area of 1×1 mm, a thickness of 450 μm, a non-saturated absorption of 8%, a modulation depth of 5%, a non-saturated loss of 3%, a saturation flux of 40μJ/cm², a relaxation time of 1 ps, and a damage threshold of 3mJ/cm².

The gain fiber 6 is a 5-cm-long fiber doped with rare earth ions, that is, ytterbium ions, with a core diameter of 4 μm and a cladding diameter of 125 μm. After it is fixed in the second ferrule 7 using epoxy resin, a vertical polishing treatment needs to be performed on both ends of the second ferrule 7.

The first ferrule 1 and the second ferrule 7 are both ceramic ferrules, with an inner diameter of 125 μm, matching the cladding diameter of the gain fiber 9, and an outer diameter equal to that of the gradient index lens 3, which is 2.5 mm. The length of the first ferrule 1 is 1 cm, and the length of the second ferrule 7 is equal to the length of the fiber 6 doped with ytterbium ions, which is 5 cm.

The first sleeve and the second sleeve are both ceramic sleeves, with a length of 2 cm and an inner diameter of 2.5 mm, the inner diameter matching the outer diameters of the first ferrule 1, the second ferrule 7, and the gradient index lens 4.

As shown in FIG. 3, the present invention also provides a high-repetition-rate passive mode-locked fiber laser, including a wavelength division multiplexer 10, a pump source 11, an optical isolator 12, and the resonant cavity 9 described in the above embodiment. The pump source 11 is a 976 nm single-mode semiconductor laser; the wavelength division multiplexer 10 is configured to couple pump light generated by the pump source 11 into the ultra-short resonant cavity 9 and output generated signal light out of the resonant cavity 9; and the optical isolator 12 is connected to the wavelength division multiplexer 10 to prevent the influence of return light on high-repetition-rate mode-locked pulse output.

### Embodiment 2

As shown in FIG. 1, this embodiment provides a compact high-repetition-rate passive mode-locked resonant cavity structure, which is the same as that in Embodiment 1, both being typical Fabry-Perot cavity structures. However, parameters of materials such as the intra-cavity gain fiber, dispersion film, and semiconductor saturable absorber mirror differ, resulting in different center spectra, spectral bandwidths, and repetition rates of the high-repetition-rate mode-locked pulse output.

The dielectric film 8 is a dichroic dielectric film applied to one end surface of the second ferrule 7 by plasma sputtering, with a film system thickness of 16 μm, a reflection center wavelength of 1550 nm, a reflection bandwidth of 1480 nm-1700 nm, a reflectivity greater than 90%, a transmission center wavelength of 976 nm, and a transmittance greater than 90%.

The semiconductor saturable absorber mirror 2 has a center wavelength of 1550 nm, a reflection bandwidth of 1450 nm-1580 nm, an area of 1×1 mm, a thickness of 450 μm, a non-saturated absorption of 7%, a modulation depth of 3%, a non-saturated loss of 4%, a saturation flux of 15 μJ/cm², a relaxation time of 10 ps, and a damage threshold of 800 μJ/cm².

The gain fiber is an erbium-ytterbium co-doped phosphate fiber with a length of 6 cm, a core diameter of 6 μm, and a cladding diameter of 125 μm. After it is fixed in the second ferrule 7 using epoxy resin, a vertical polishing treatment needs to be performed on both ends of the second ferrule 7. The length of the second ferrule is equal to the length of the gain fiber, which is 6 cm.

As shown in FIG. 3, when the resonant cavity of this embodiment is used in a high-repetition-rate passive mode-locked fiber laser, the pump source used is a 976 nm single-mode semiconductor laser.

### Embodiment 3

As shown in FIG. 1, this embodiment provides a compact high-repetition-rate passive mode-locked resonant cavity structure, which is the same as that in Embodiment 1, both being typical Fabry-Perot cavity structures. However, parameters of materials such as the intra-cavity gain fiber, dispersion film, and semiconductor saturable absorber mirror differ, resulting in different center spectra, spectral bandwidths, and repetition rates of the high-repetition-rate mode-locked pulse output.

The dielectric film 8 is a dichroic dielectric film applied to one end surface of the second ferrule by plasma sputtering, with a film system thickness of 18 μm, a reflection center wavelength of 1950 nm, a reflection bandwidth of 1850 nm-2050 nm, a reflectivity greater than 90%, a transmission center wavelength of 1570 nm, and a transmittance greater than 95%.

The semiconductor saturable absorber mirror 2 has a center wavelength of 2000 nm, a reflection bandwidth of 1890 nm-2060 nm, an area of 1×1 mm, a thickness of 450 μm, a non-saturated absorption of 20%, a modulation depth of 12%, a non-saturated loss of 8%, a saturation flux of 65pJ/cm², a relaxation time of 10 ps, and a damage threshold of 2mJ/cm².

The gain fiber is a thulium-doped silica fiber with a length of 4 cm, a core diameter of 5 μm, and a cladding diameter of 125 μm. After it is fixed in the second ferrule 7 using epoxy resin, a vertical polishing treatment needs to be performed on both ends of the second ferrule 7. The length of the second ferrule is equal to the length of the gain fiber, which is 4 cm.

As shown in FIG. 3, when the resonant cavity of this embodiment is used in a high-repetition-rate passive mode-locked fiber laser, the pump source used is a 1570 nm single-mode semiconductor laser.

The embodiments in this specification are described in a progressive manner, with each embodiment focusing on differences from other embodiments, and similar parts among the embodiments can be referred to each other.

The above embodiments of the present invention are merely examples to clearly illustrate the present invention and are not intended to limit the implementation of the present invention. For those of ordinary skill in the art, other variations or modifications in different forms can be made based on the above description. It is neither necessary nor possible to exhaustively list all implementation methods here. Any modifications, equivalent substitutions, improvements, and the like made within the spirit and principles of the present invention shall be included within the scope of protection of the claims of the present invention.

1. A compact high-repetition-rate passive mode-locked resonant cavity structure, comprising a first ferrule, a semiconductor saturable absorber mirror, a first sleeve, a gradient index lens, a second sleeve, a gain fiber, a second ferrule, and a dielectric film; wherein
the semiconductor saturable absorber mirror is disposed on one end surface of the first ferrule, the first ferrule is spacedly connected to one end of the gradient index lens via the first sleeve, an other end of the gradient index lens is spacedly connected to the second ferrule via the second sleeve, the dielectric film is disposed on another end surface of the second ferrule, and the gain fiber is located in the second ferrule.

2. The resonant cavity structure according to claim 1, wherein the first sleeve is provided on an outer side of the first ferrule and the gradient index lens, and the second sleeve is provided on an outer side of the second ferrule and the gradient index lens.

3. The resonant cavity structure according to claim 1, wherein distances from the gradient index lens to the semiconductor saturable absorber mirror and the gain fiber are adjustable.

4. The resonant cavity structure according to claim 1, wherein a material refractive index distribution of the gradient index lens gradually decreases along a radial direction, causing continuous refraction of light during axial transmission, and achieving smooth and continuous convergence of light rays to a point.

5. The resonant cavity structure according to claim 1, wherein the dielectric film has a reflectivity greater than 70% for signal light, and a transmittance greater than 70% for pump light.

6. The resonant cavity structure according to claim 1, wherein a modulation depth of the semiconductor saturable absorber mirror is from 1% to 30%.

7. The resonant cavity structure according to claim 1, wherein a length of the gain fiber is from 1 cm to 9 cm.

8. The resonant cavity structure according to claim 1, wherein the gain fiber is a fiber doped with rare earth ions, and the rare earth ions for doping comprise one or more types of erbium, ytterbium, thulium, and holmium.

9. The resonant cavity structure according to claim 1, wherein the gain fiber is fixed in the second ferrule with a matched size using epoxy resin, and a polishing treatment is performed at an end surface.

10. A fiber laser comprising a wavelength division multiplexer, a pump source, an optical isolator, and the compact high-repetition-rate passive mode-locked resonant cavity structure according to claim 1 the wherein
the wavelength division multiplexer is configured to couple pump light generated by the pump source into the resonant cavity structure and output generated signal light out of the resonant cavity structure, and the optical isolator is connected to the wavelength division multiplexer.
